(19) United States
(12) Patent Application Publication
(10) Pub. No.: US 2014/0076482 A1
(43) Pub. Date: Mar. 20, 2014

(54) Fireproof System Using Jacketed Fibrous Endothermic Mats

(71) Applicants: Brandon Aloys Kunk, Kountze, TX (US); Mark Richard Eckhardt, Georgetown, TX (US); Brian Aloys Kunk, Kountze, TX (US); Darrell Richard Kunk, Kirbyville, TX (US)

(72) Inventors: Brandon Aloys Kunk, Kountze, TX (US); Mark Richard Eckhardt, Georgetown, TX (US); Brian Aloys Kunk, Kountze, TX (US); Darrell Richard Kunk, Kirbyville, TX (US)

(21) Appl. No.: 14/022,833

(22) Filed: Sep. 10, 2013

Related U.S. Application Data
(60) Provisional application No. 61/743,951, filed on Sep. 14, 2012.

(51) Int. Cl. E04B 1/94; B32B 3/18

(52) U.S. Cl. CPC E04B 1/94; B32B 3/18
USPC 156/185; 428/74

(57) ABSTRACT

A fire protective composite comprising a jacketed fibrous endothermic mat and method of wrapping thereof, the jacket material preferably including impregnated fiberglass fabric, the composite designed for fire protection of structural elements such as steel I-beams and complex joints, electrical conduits and cable trays, LP-gas container and vessel skirts and valves.

This application relates to and claims priority to co-pending patent application Ser. No. 61/743,951, entitled Fireproof SIStem, inventors Brandon Kunk, Mark Eckhardt, Brian Kunk, Darrell Kunk, filed Sep. 14, 2012. The above referenced provisional application is herein and hereby incorporated by reference in its entirety.

### FIELD OF THE INVENTION

The invention lies in the field of providing fire protection for structural elements such as structural steel, including I-beams and joints thereof; circuits, including electrical conduits and cable trays; vessel skirts and valves; and LP-gas containers and the like.

### BACKGROUND OF THE INVENTION

It is known that there is need to provide fire protection for structural elements such as steel I-beams and joints, for circuits including electrical conduits and cable trays, for vessel skirts and valves, and for LP-gas containers and the like.

Steel I-beams and joints, to address a category of the more difficult elements to protect, are commonly protected by using a combination of concrete and sand, or a pyrocrete compound. Generally, a mold is formed and a combination of concrete and sand, or pyrocrete, is set in the mold around the structural element, to a sufficient thickness to pass the appropriate UL and/or ASTM and/or NFPA test for fire protection. The most efficient approach is for the concrete/sand or pyrocrete to be added to the structural element before it is shipped to a job and secured in final position. However, the downside to that approach is that, after the addition of concrete or pyrocrete, such structural elements are heavy, unwieldy and difficult to maneuver. Further, complex joints involving such structural elements can only be covered with the concrete/sand or pyrocrete at the site, at the conclusion of the construction. Forming proper casts for the joints and molding the concrete/sand or pyrocrete around the joints, in place at the site, particularly around complex joints, is time consuming and labor intensive. Further again, whenever an alteration to or an inspection of any element or joint is required, the concrete/sand or pyrocrete must be chipped away. After the inspection or alteration a new cast of the concrete/sand or pyrocrete must be formed and set in place, at the site, again a time and labor consuming process.

As an alternative, it was shown years ago that a certain fibrous endothermic mat, in particular Interam from 3M, could be wrapped and bound around structural steel elements like an I-beam at a sufficient thickness that the wrapped element passed the appropriate UL/ASTM tests for adequate fire protection at high temperatures. Wrapped mats have the advantage of being significantly lighter than concrete/sand or pyrocrete, easier to deal with, more quickly bound over structural elements at the completion of construction using steel bands, and more easily removed for inspection or repair. Further, stainless steel envelopes were taught to be wrapped around the outside of the wrapped Interam mats, the wrapped mats being symmetrical, to preserve and protect the integrity of the mats vis-à-vis the environment since fire protective systems for structural elements are expected to endure in the environment for twenty years or more.

Thus, wrapped mats were known for fire protection of structural steel and had the advantages: (1) of permitting greater ease in the construction of the structure itself, eliminating the handling of units covered with concrete/sand or pyrocrete; (2) of offering greater ease in the addition of the protective layer itself; and (3) of providing greater flexibility in regard to future inspections, repairs and alterations of the structure, as bands binding the mats were known to be quickly cut and mats quickly removed for inspection or alteration. Mats could be relatively quickly replaced. However, notwithstanding the demonstration of the fire protection effectiveness and ease of use, wrapped fibrous endothermic mats did not generally replace the concrete/sand or pyrocrete process for fire protection of structural steel. The reasons for this appear to be at least three-fold.

(1) Fibrous endothermic mats had not been disclosed to be used to cover complex joints, sometimes referred to as “block-outs.” See pages from 3M website (information disclosure statement and provisional application incorporated by reference) illustrating the absence of a teaching of the use of Interam for joints or block-outs. Absence of a teaching of use of Interam mats for joints reflected a concern about the flexibility of the mats, about the capacity of the mats to make turns without breaching the mat's physical integrity and fire fighting effectiveness, and further, reflected a concern about the mats durability because steel sleeves employed to protect the mats from the environment were problematic for complex joints. The steel sleeves were the only protective sleeves taught to integrate with the mats without harm to the functioning of the fibrous endothermic material. Interam mats thus were not offered as a complete solution to the fire protection issue for structural steel and, likely as a result, have not been extensively used for structural steel. This result appears true for other structural elements which have similar configuration issues.

(2) It was believed that the chemical and/or physical firefighting integrity of fibrous endothermic mats, even with stainless steel sleeves, would not hold up for, and would be breached by, the physical and mechanical and chemical forces and events occurring in a workplace over a period of twenty years or more exposure. It was suspected that the fibrous endothermic mats incompletely encapsulated by stainless steel sleeves would lose chemical firefighting effectiveness by dissipation and leaking as a result of exposure to workplace heat events.

(3) To the extent any consideration was given to encapsulating Interam mats with a fiberglass fabric, analogous to the use of fiberglass fabric in the heat/cold insulation industry (and there is no known evidence that such consideration was given,) the inventors discovered that it was believed that such jackets, melting or dissolving upon a fire, would obstruct the capacity of the mat to be tightly bound around the structural element and protect it from high heat.

Wrapped jacketed mats in general (not endothermic mats) were known for limited fire protection in some applications, but they were not used for wrapping structural steel I-beams or joints and the like because of the high heat protection standard required to be met. Further, such jacketed mats were at least four to five times thicker than the instant wrapped jacketed fibrous endothermic mats, which limited the prior art mats usefulness.

Further, in regard to structures that generate heat such as electrical circuits, the prior art wrapped jacketed mats were known to have a problem of impermissibly trapping heat within the structures during normal operation.

The instant invention, of jacketed fibrous endothermic mats, including custom formed jacketed mats, addresses all of the above problems. The instant invention first demonstrates a capacity to provide the requisite high heat fire protection for structural elements, from structural steel to electrical conduits and cable trays, to LP-gas containers and to vessel skirts and valves, with significantly thinner wrappings, perhaps 3 to 4 times thinner, and notwithstanding the melting or dissolving of the jacket upon high heat, and notwithstanding the bending of the jacketed mats around complex joints. Further, in applications where the structure to be wrapped generates heat in normal use, such as applications involving electrical circuits, wrapped jacketed fibrous endothermic mats have a capacity to absorb normal day to day heat of operation given their inherent endothermic capacity. Such low level absorption of the heat of normal operation by a mat with endothermic capacity does not impermissibly detract from the remaining endothermic capacity of the mats to absorb heat from a catastrophic fire event.

The instant inventors had prior experience in the use of jacketed insulation mats for the conservation of heat in industrial applications, and had tested the effectiveness over time of certain jacketed insulation mats for the conservation of heat. Based on their prior experience and testing, the instant inventors envisioned that a proper “jacketing” of a fibrous endothermic mat, on the one hand, would not negatively impact the fire protection effectiveness of the endothermic mat when the jacket dissolved, and the jacketing would solve the problems of the lack of endurance of the mats over a long period of time in an industrial environment, and further the jacketed mats could be formed into complex configurations without sacrificing fire effectiveness. Based on their vision, the inventors proceeded to design a prototype and test whether jacketed fibrous endothermic mats would be able to be wrapped around structural elements to meet the relevant UL/ASTM/NFPA standards, including the high standard for structural steel. If so, wrapped jacketed fibrous endothermic mats could become a complete solution to fire protection for many industrial applications, including not only the difficult structural steel beams and joints but also heat emitting electrical conduits and cable trays, and LP-gas containers and vessel skirts and valves. The inventors theorized that at catastrophic temperature levels the jackets would dissipate or melt and disappear, but the remaining fibrous endothermic mats would yet be capable of performing their required fire protective functions. And below the catastrophic temperature levels, the jackets would adequately protect the mats from direct contact with industrial workplace heat and contamination and from loss of fire protection integrity due to exposure to workplace environmental conditions, including minor heat events, and do so for many years. Testing, discussed below, has proved the inventors' vision and theorizing to be correct.

### SUMMARY OF THE INVENTION

The instant invention comprises a fire protective composite, or jacketed mat, configured to protect structural elements, such as steel I-beams and structural joints as well as electrical conduits and cable trays, LP-gas containers, vessel skirts and valves and the like. The composite includes a flexible jacket including a fiberglass material impregnated with a chemical, water and oil resistant compound. Preferably, the material is impregnated with a silicon rubber or Teflon resin. The flexible jacket encloses one or more fibrous endothermic mats. The jackets preferably have a melting temperature of approximately 500° F.+/−100° F., and the fibrous endothermic mat preferably includes at least one of Interam and Endoflex.

The invention also includes a method for fire protecting structural elements, such as steel I-beams and structural joints, electrical conduit and cable trays, LP-gas containers, vessel skirts and valves and the like, including complex structures, comprising wrapping and binding two or more of the jacketed mats, above, including custom designed jacketed mats, around a structural element with such overlap and in such thicknesses that the wrapped structural element passes the relevant ASTM or UL or NFPA fire protection test.

The invention includes a composite for the protection of industrial structural elements, such as steel I-beams and structural joints as well as electrical conduits and cable trays, LP-gas containers and vessel skirts and valves, from sustained fire. The invention includes a flexible jacket including material impervious to weather and industrial workplace wear and tear. The jacket is structured and composed to maintain integrity under workplace abrasive contact and exposure to oil and water. The jacket encloses an approximately ¼ inch to 5-inch thickness of one or more fibrous endothermic mats to form a composite. The jacket and mat may assume a custom design shape. The composite is structured for wrapping around at least a portion of an industrial structural element, as above. The invention includes one or more jacketed fibrous endothermic mats capable of at least meeting the standards of at least one of the ASTM E119 test and UL 1709 test for structural steel when suitably wrapped and installed.

Preferably the jacket material includes a fiberglass fabric material impregnated with a water, oil and chemical resistant compound.

The invention includes methods for protecting the above industrial structural elements by layering a plurality of fire protective composites around the structural element, and including a suitable overlapping of the plurality of composites, and a suitable binding of the composites, and using collars to overlap butt seams between composites and using sealant to fill in gaps of between ¼ inch and 2 inches.

### BRIEF DESCRIPTION OF THE DRAWINGS

A better understanding of the present invention can be obtained when the following detailed description of the preferred embodiments are considered in conjunction with the following drawings, in which:

FIGS. 1A and 1B illustrate cross-sections of illustrative jacketed fibrous endothermic mats.

FIGS. 2A-2C illustrate wrapping techniques for a structural steel I-beam using the jacketed fibrous endothermic mats, including wrapping a structural steel I-beam using existing fireproofing and fire proofing bricks.

FIGS. 3A-3B illustrate wrapping three sides of a structural steel I-beam and mating the wrapping system of the jacketed fibrous endothermic mats with existing fire proofing on a structure.

FIGS. 4A-4I illustrate technique for wrapping of electrical conduit including a curved conduit.

FIGS. 5A-5C illustrate wrapping a cable tray.

FIGS. 6A-6E illustrate custom jacket designs and techniques for LPG containers, vessel skirts, small diameter pipes and valves.

FIGS. 7A-7BB illustrate jacket designs and techniques for wrapping complex structural steel joints.

The drawings are primarily illustrative. It would be understood that structure may have been simplified and details omitted in order to convey certain aspects of the invention. Scale may be sacrificed to clarity.

### DESCRIPTION OF THE PREFERRED EMBODIMENTS

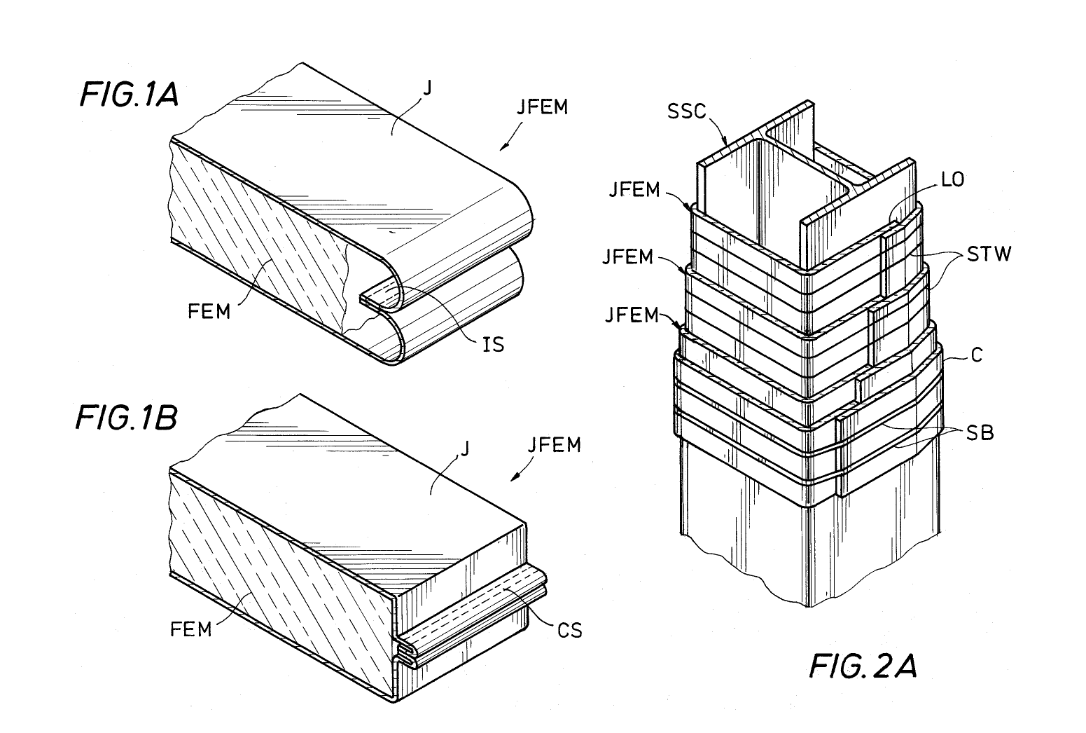

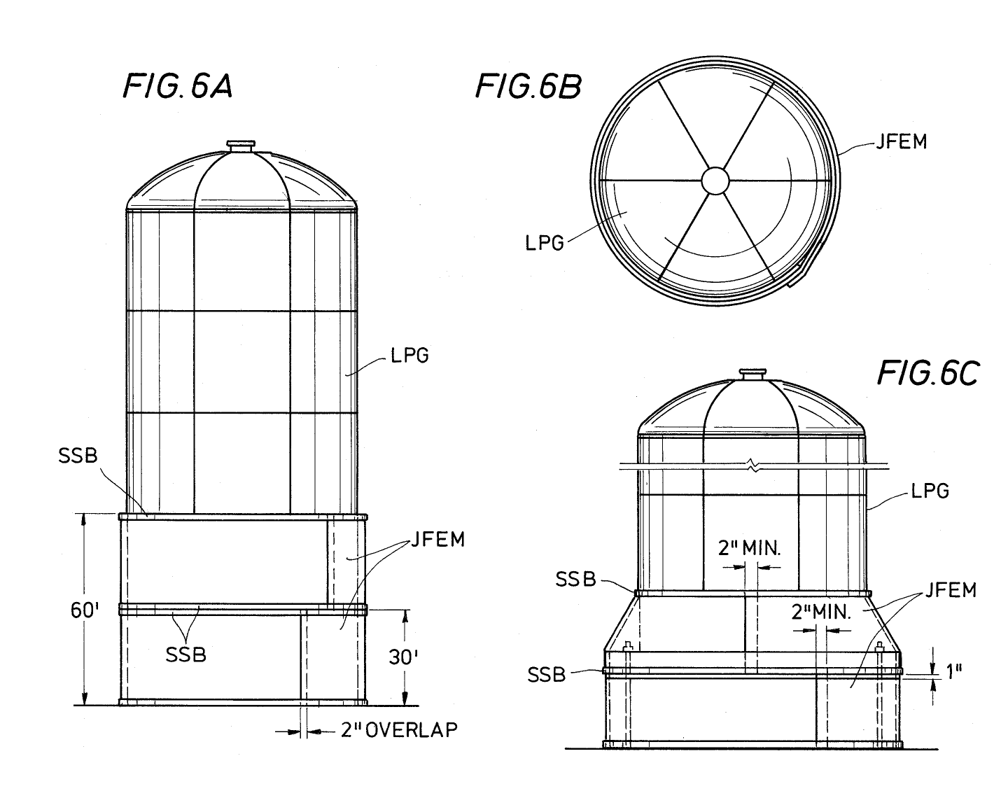

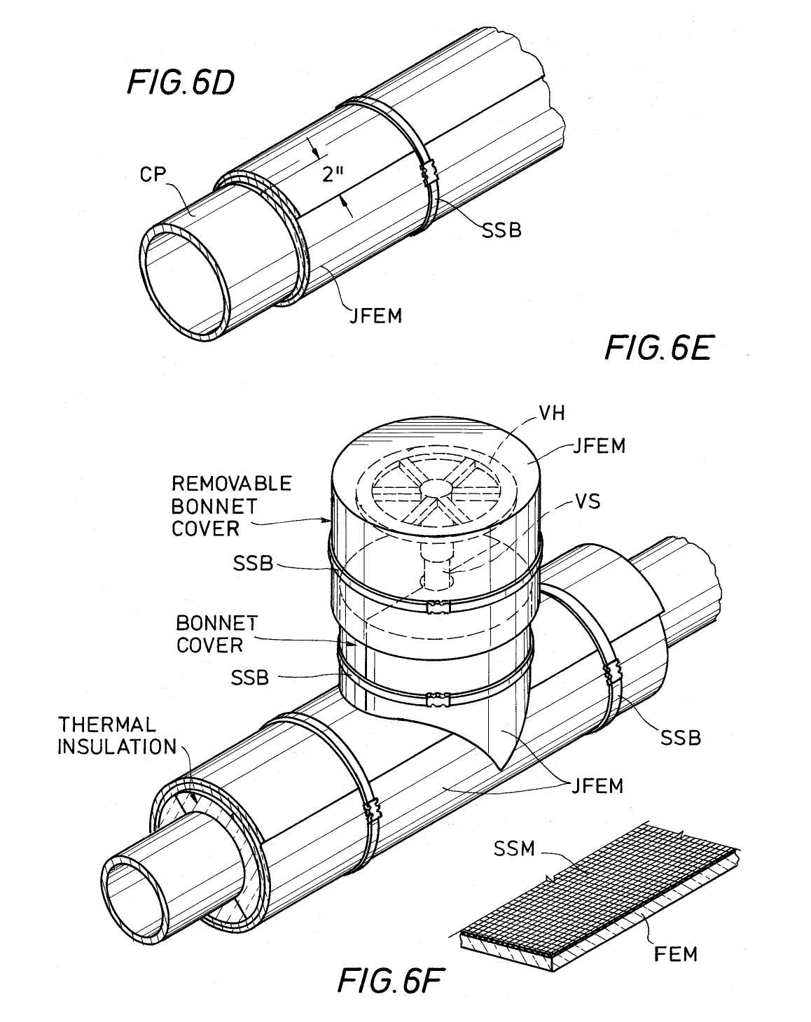

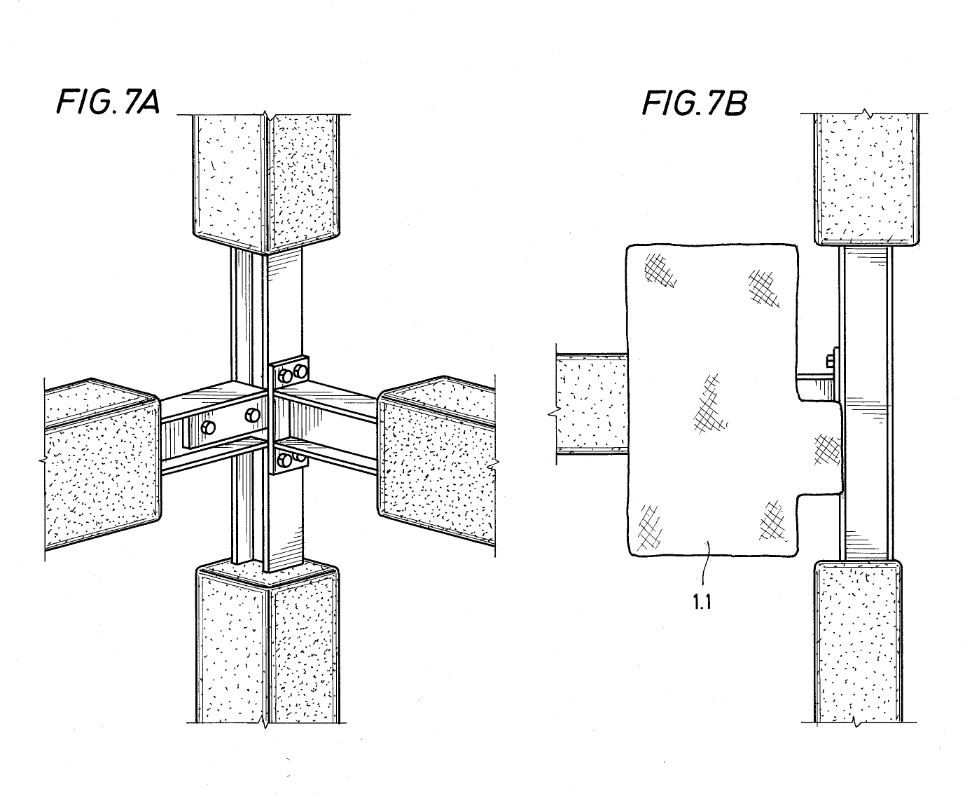

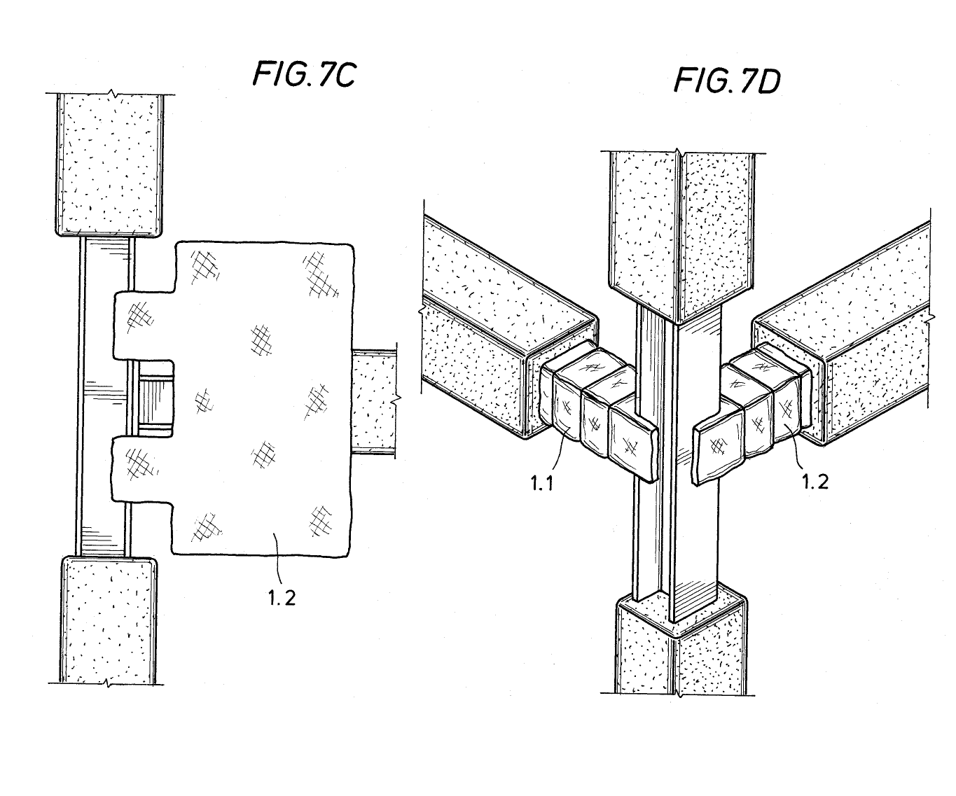

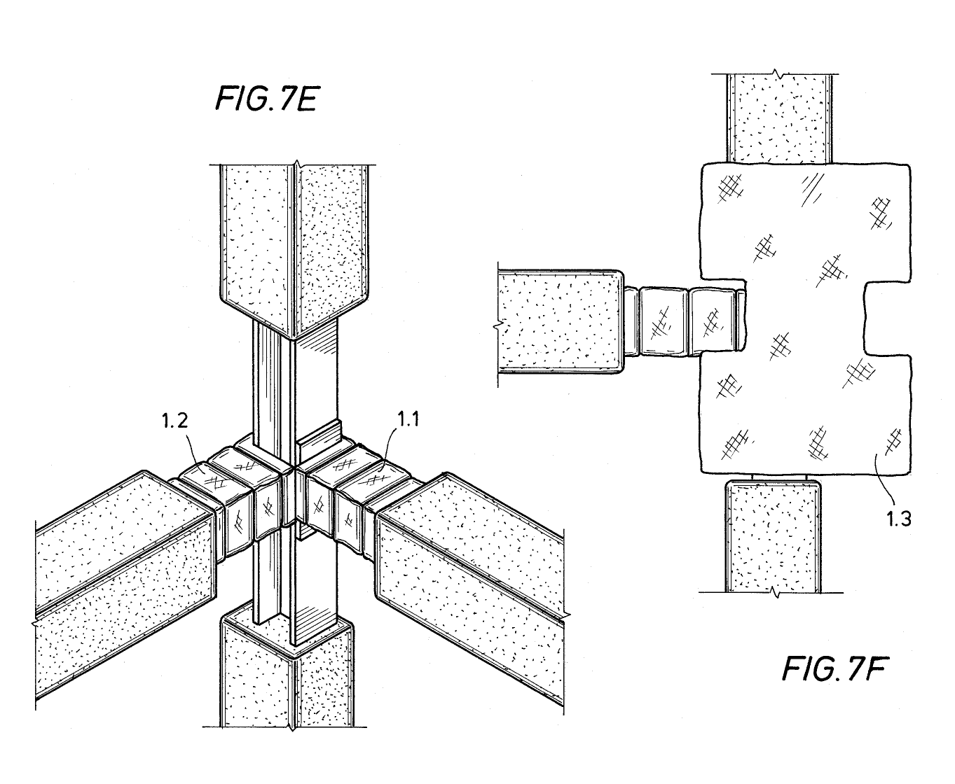

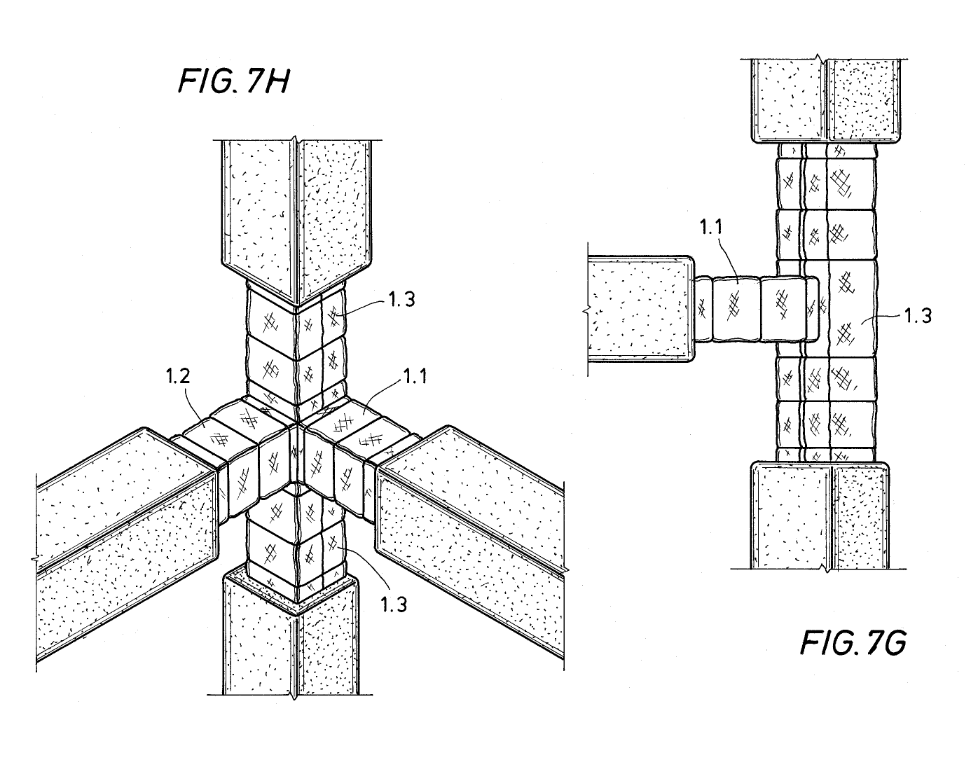

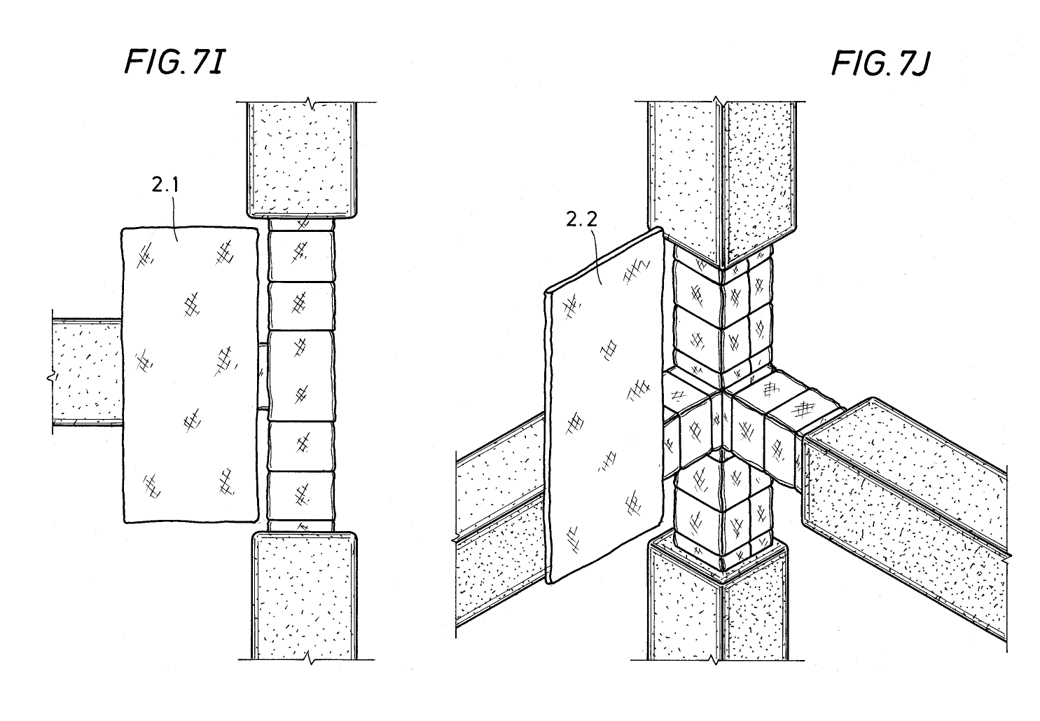

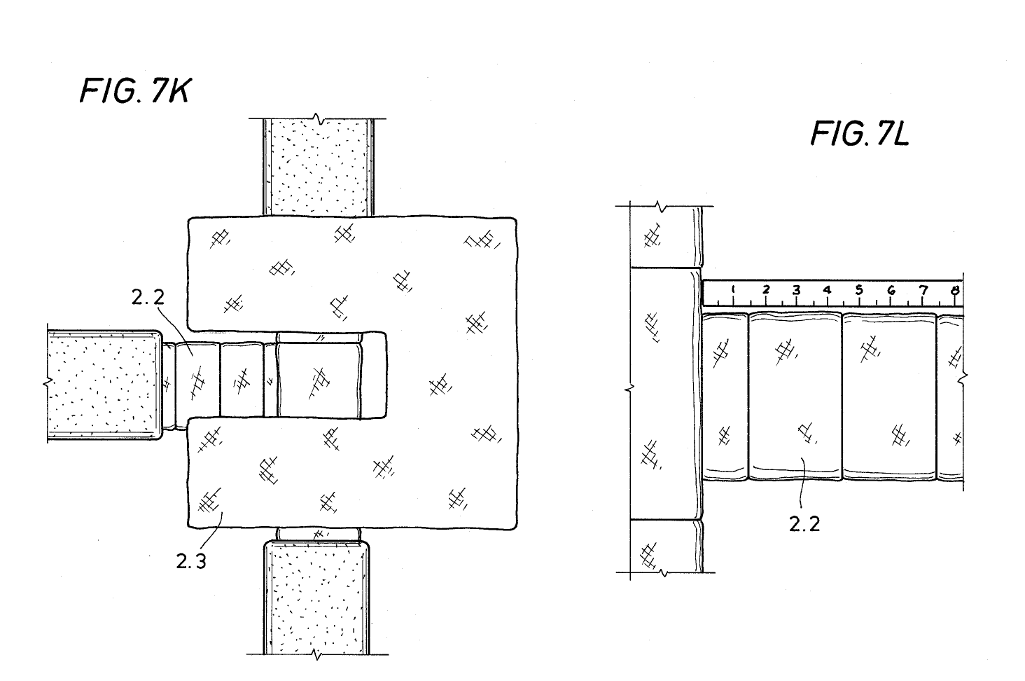

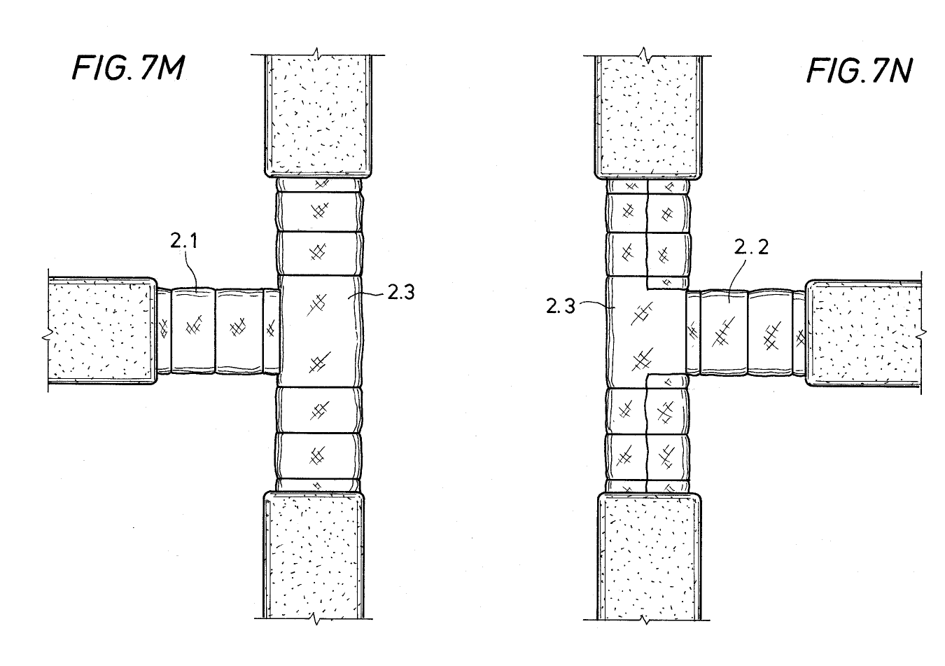

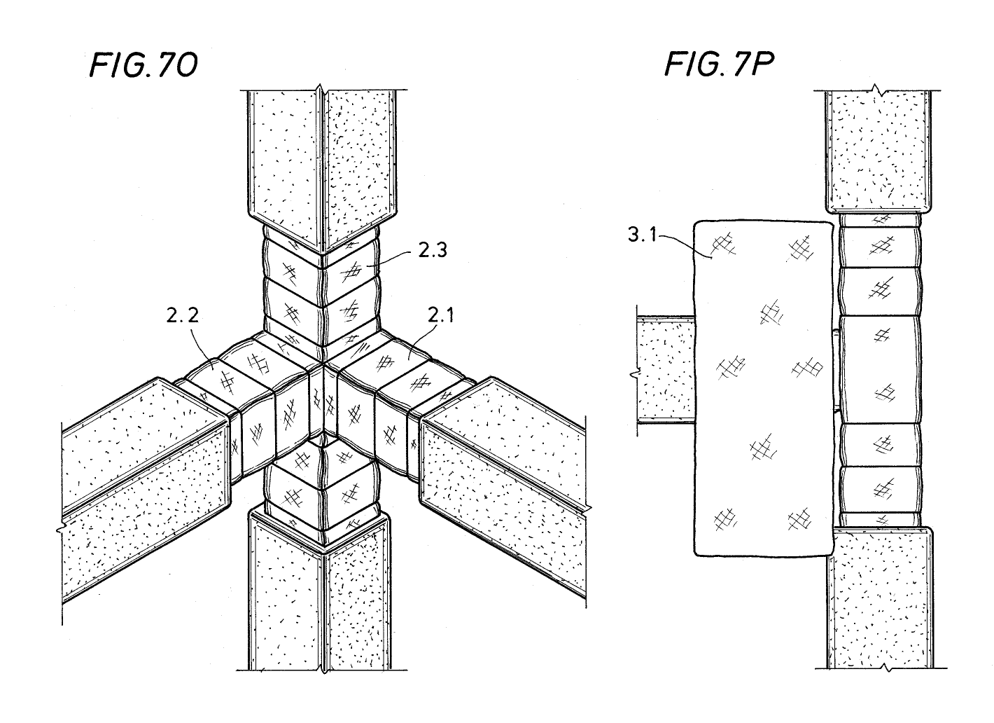

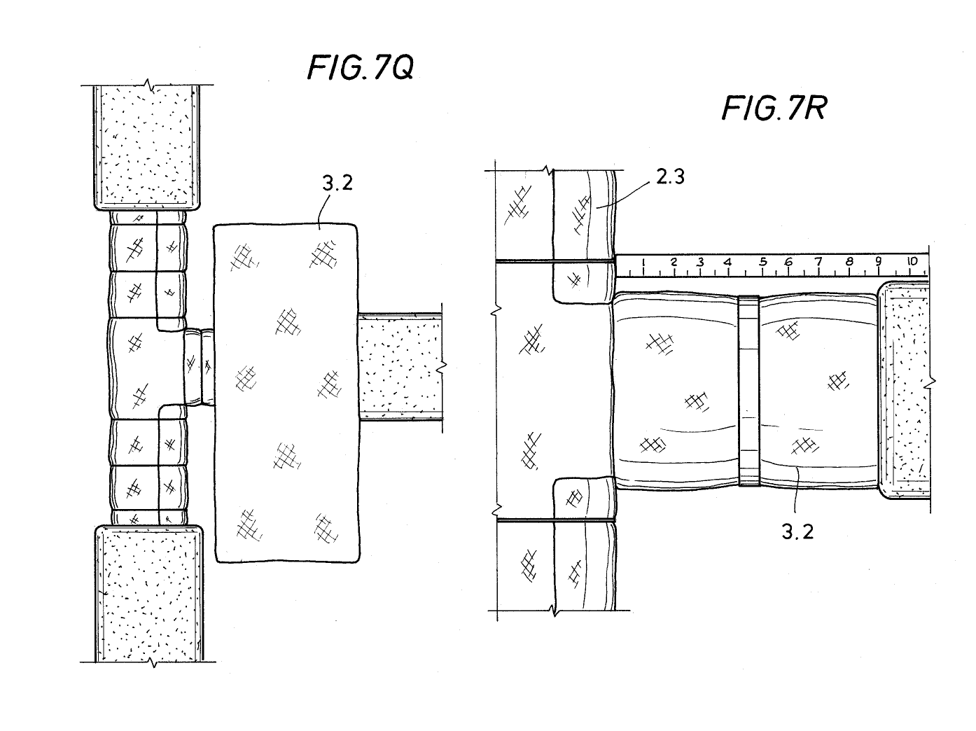

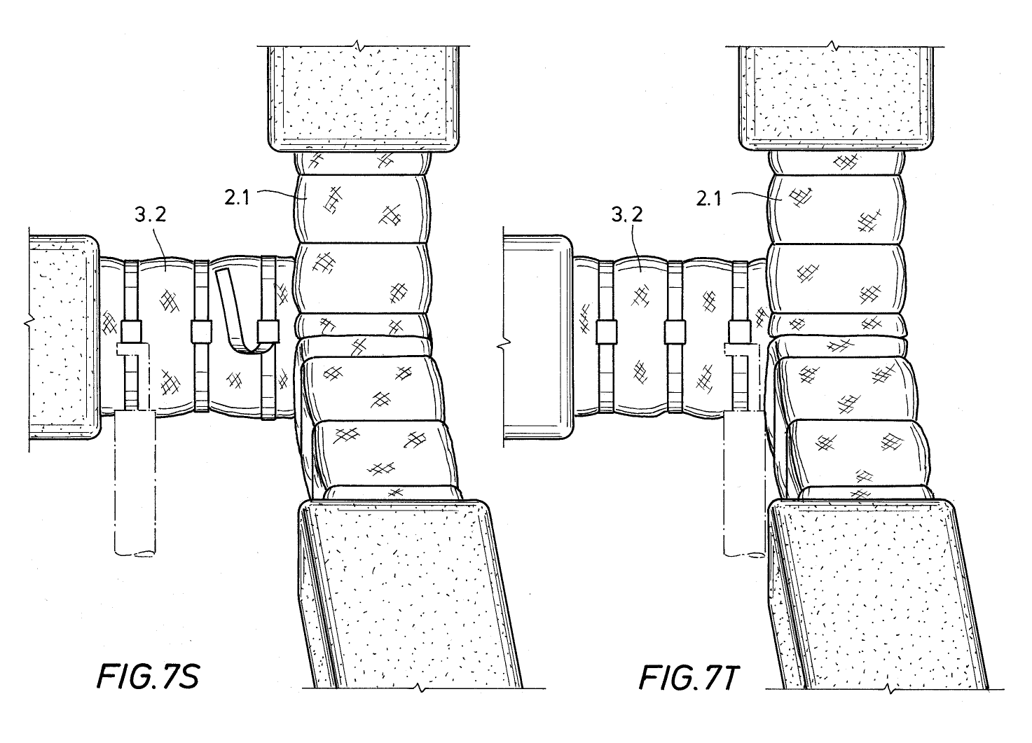

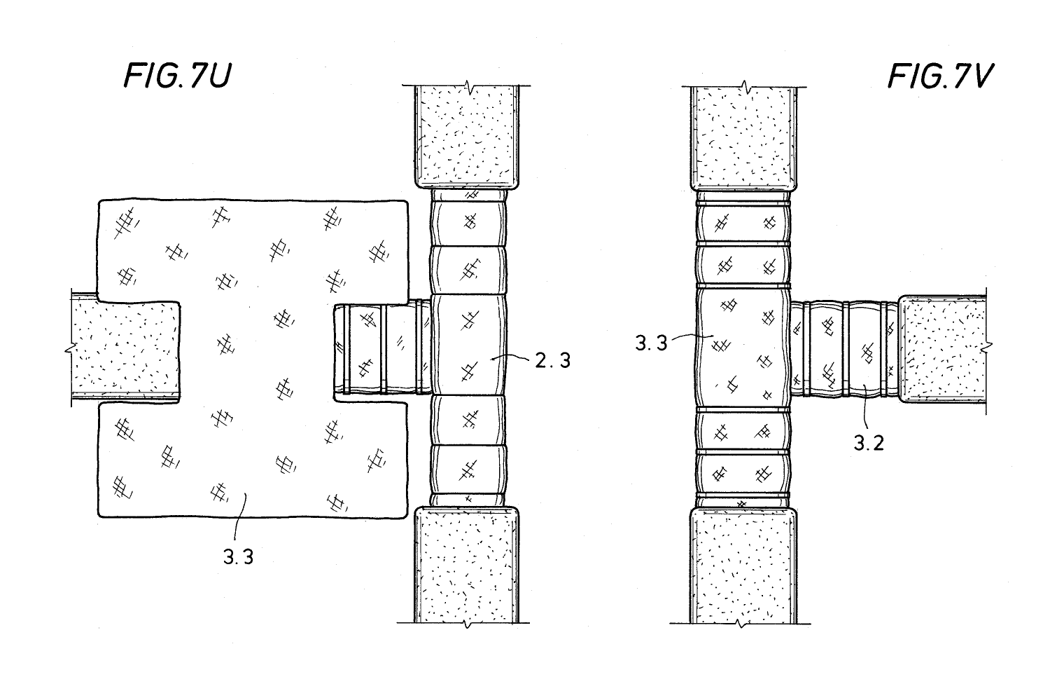

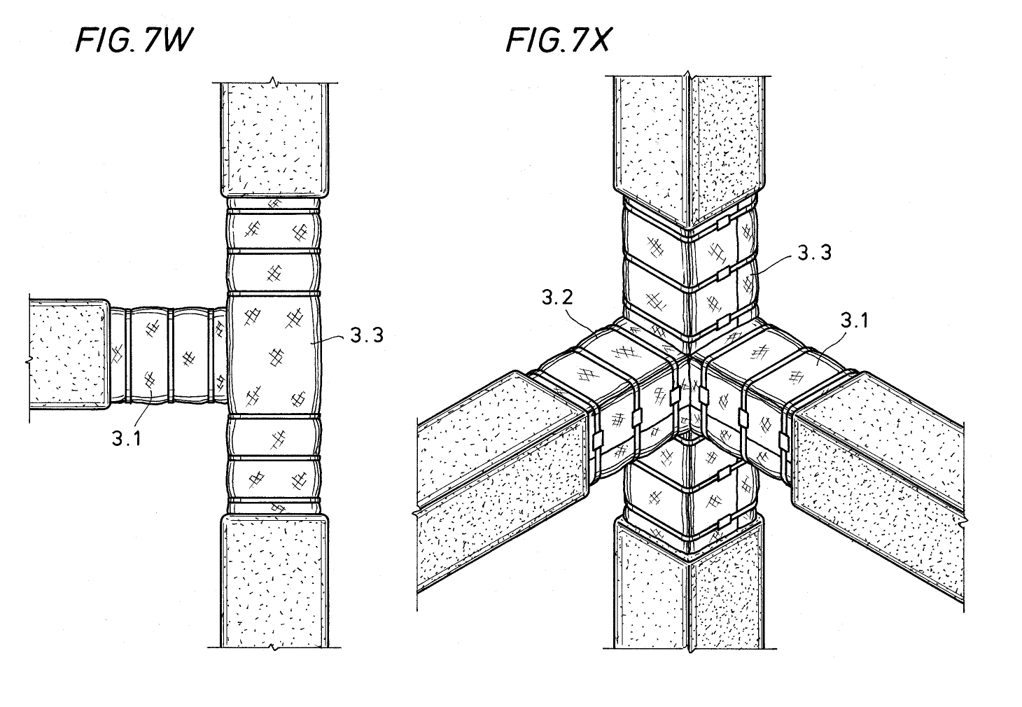

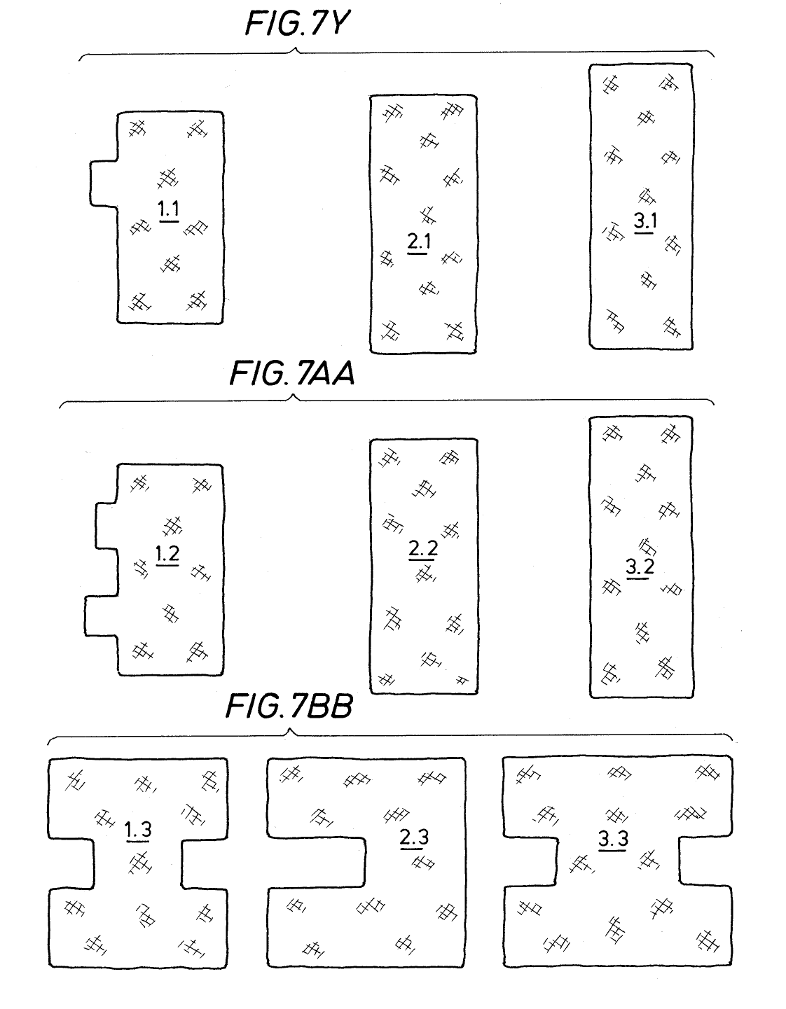

As illustrated in sectional drawings FIGS. 1A and 1B, the instant jacketed mat or composite comprises flexible jackets J enclosing a fibrous endothermic mat FEM. The jacketed mat JFEM is designed to protect critical items that can be subjected to fire exposure. During a fire a chemical reaction of the inner core material of the endothermic mat FEM, in reaction to the heat created by the fire, creates a cooling effect to the item protected. The chemical reaction might include releasing chemically bound water. Even during normal operation heat generated by the wrapped structure can be absorbed through the jacket by the core material, protecting against the wrapping impermissibly trapping generated heat. Such flexible mat systems are ideal for industrial fire proofing due to their ability to conform to complex configurations and wrap around various substrates. See FIGS. 6 and 7 discussed below. Further, the jacketed mat is easily removable and replaceable to allow for inspection or maintenance of the protected items.

FIGS. 1A and 1B illustrate in cut-away a jacketed fibrous endothermic mat JFEM. Jacket J of preferably fiberglass fabric impregnated with a chemical, water and oil resistant compound, encloses mat FEM which comprises a fibrous endothermic mat, such as Interam. The jacket encapsulates the mat. FIG. 1A shows an inside seam IS, and FIG. 1B shows an exterior closing seam CS.

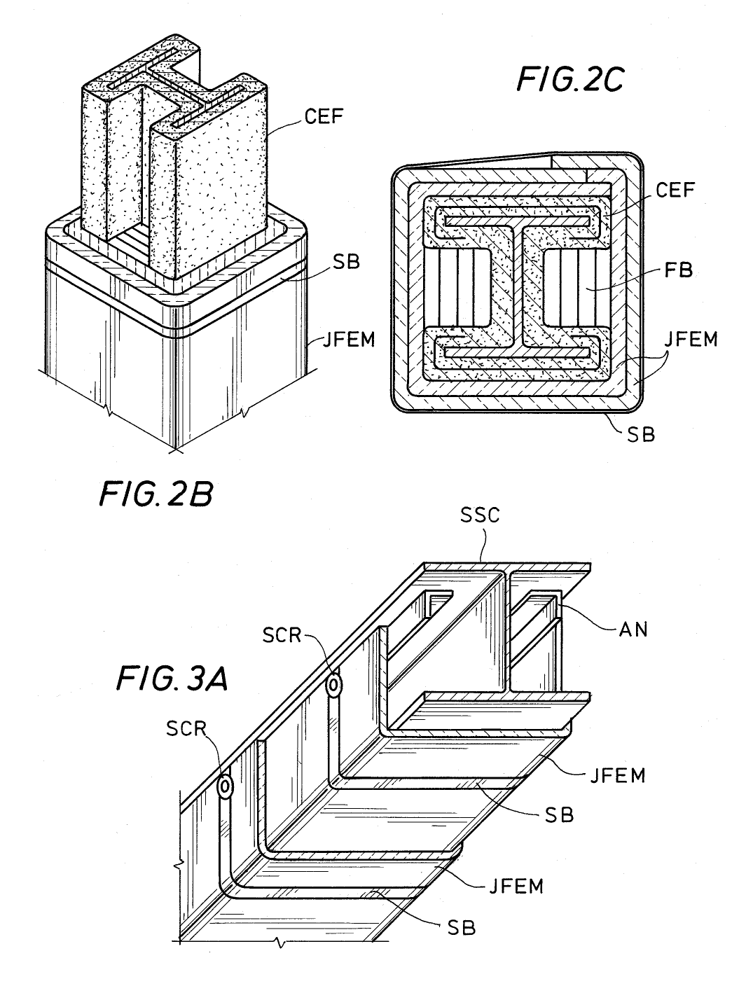

FIGS. 2A and 2B illustrate a technique of enclosing a stainless steel column SSC with the jacketed fibrous endothermic mat JFEM. Three layers of wrapping with the jacketed mat are disclosed, with the second and third outer layers partially cut-away for visual convenience. Stainless steel tie wires STW bind the first and second layers, being inner layers. The third layer or outer layer of JFEM is preferably bound with half-inch wide steel banding SB, including on a 4-inch wide collar C. FIG. 2A illustrates that in the circumferential direction, the seams of an underlying mat and an overlying mat should be offset by at least two inches. The seams between layers in the vertical direction can comprise butt seams. The butt are preferably covered with an at least 4-inch wide collar bound over the butt seam with steel banding SB, preferably at least half-inch wide steel banding.

FIGS. 2B and 2C illustrate a technique for wrapping a steel column that already has some existing fire proofing. The existing steel column with some fire proofing is illustrated by element CEF. Fire proofing bricks FB are placed inside the web of the I-beam. The steel column with existing fireproofing and fireproofing bricks is wrapped in two layers of jacketed fibrous endothermic matting. The circumferential seams between the beginning and ending of one piece of matting are preferably offset, preferably at least 2-inches. Again, stainless steel banding SB bands the outer layer and tie wires TW, not shown, would band the inner layer.

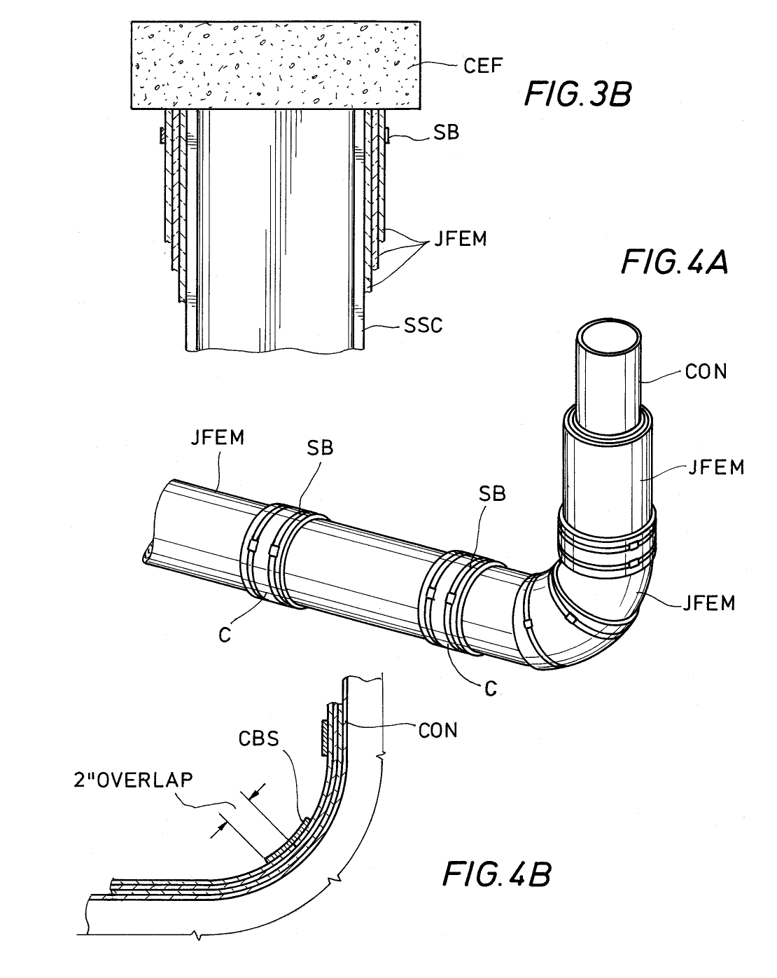

FIG. 3A illustrates a technique for binding three sides of a steel I-beam SSC. In this case an angle welded to the beam is inset in order to provide attachment means. The angle welded to the beam in FIG. 3A is shown as element AN. Self tapping screws with stainless steel washers SCR are shown attaching stainless steel binding SB to the angle AN welded to the beam. Two layers of jacketed material JFEM are shown.

FIG. 3B illustrates a joint of a jacketed fibrous endothermic mat JFEM with existing fireproofing CEF. A tight butt joint is provided, as shown by FIG. 3B. Stainless steel banding SB holds the layers of JFEM against the structural steel element and tightly abutting the existing fireproofing.

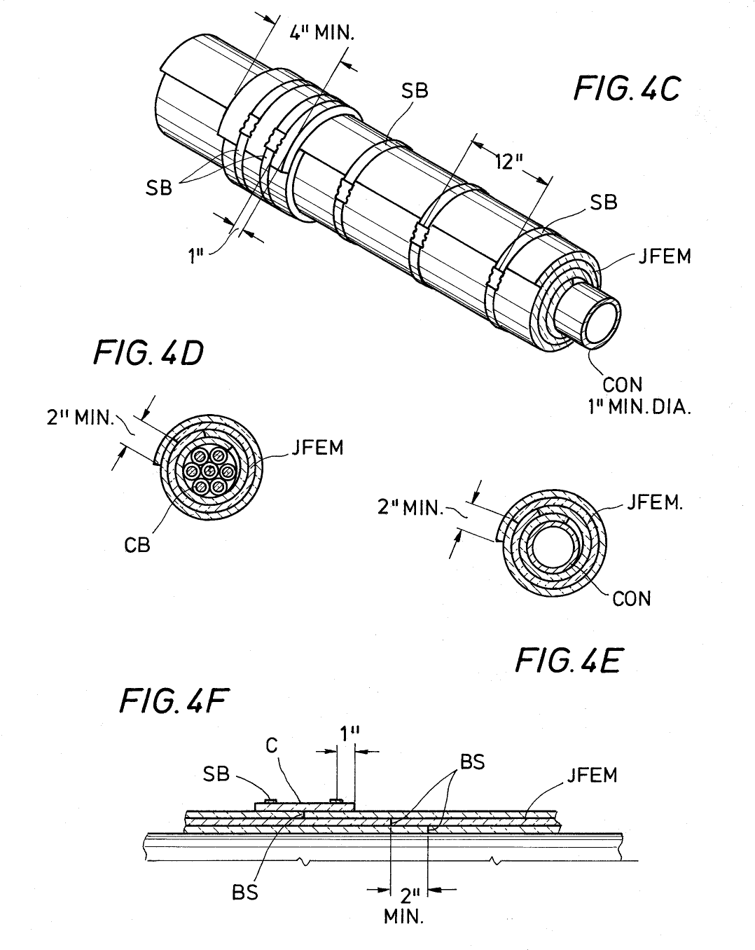

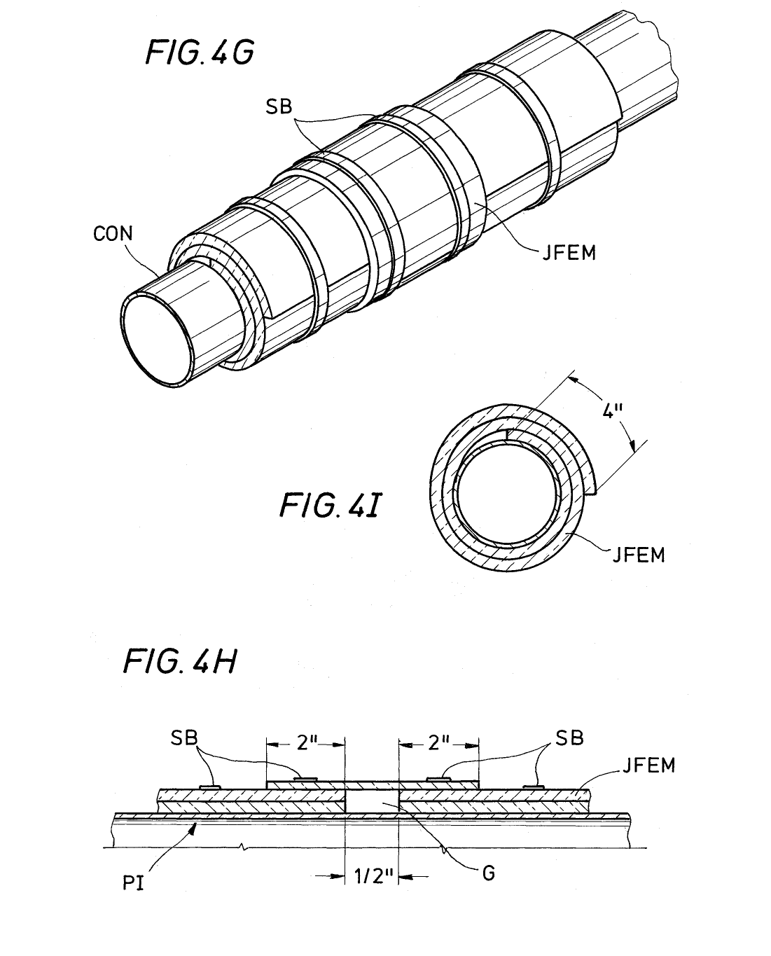

FIGS. 4A and 4B illustrate wrapping a pipe elbow. Stainless steel banding SB holds collars C over butt seams between jacketed wrapping elements JFEM. The conduit is indicated by element CON. FIG. 4B illustrates in greater particularity the placement of collar C over butt seams BS in the elbow cross-section view.

FIG. 4C illustrates wrapping conduits CON with jacketed mat JFEM held in place by stainless steel bands SB spaced at 12 inches on center. A minimum 4-inch wide collar C is shown held in place by stainless steel bands SB. The stainless steel bands are preferably one inch from the edge of the collar.

FIGS. 4D and 4E illustrate wrapping a minimum 1-inch cable or cable bundle CB and/or a minimum 1-inch conduit CON.

FIG. 4F illustrates placing a minimum 2-inch offset of butt seams between layers, together with the placement of a collar C, minimum 4 inches wide, over the butt seam of the outer layer having stainless steel bands SB placed one inch from the end of collar C.

FIG. 4G presents a further perspective of wrapping a minimum 1-inch conduit with a JFEM mat and JFEM collar using stainless steel banding SB.

FIG. 4H illustrates that there may be a 1-inch gap between JFEM layers over the protected item PI. The collar should be increased in size in such case to include 2 inches on each side of the 1-inch gap as well as the 1-inch gap.

FIG. 4I illustrates a 4-inch circumferential difference between the beginning and end of a JFEM element circling a small conduit CON.

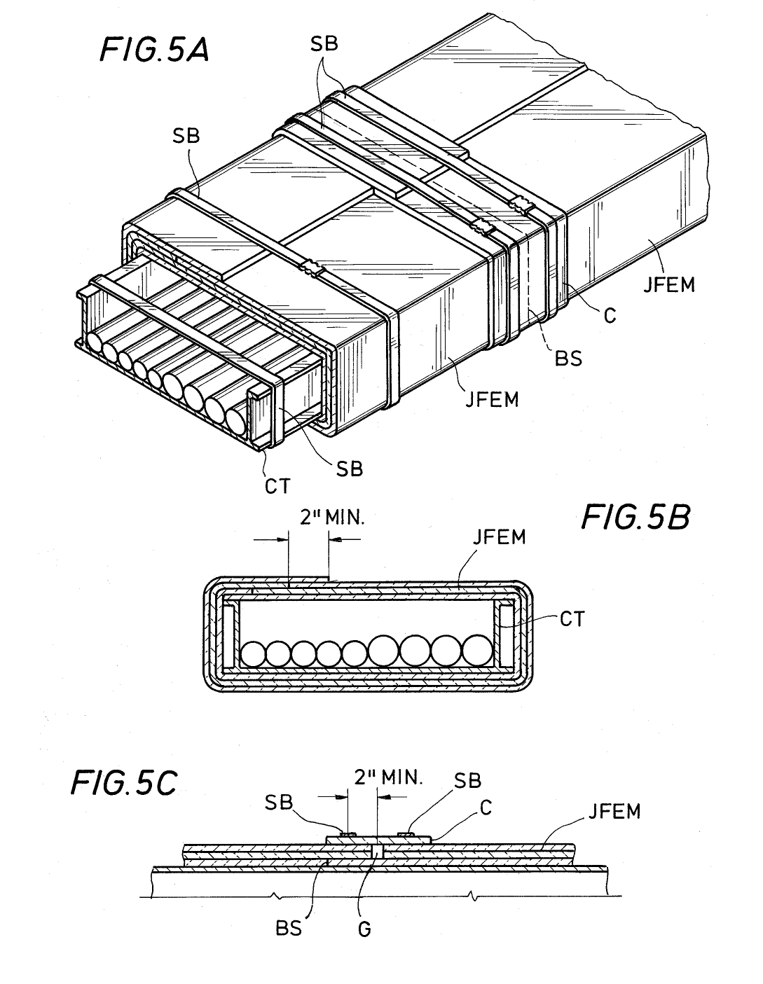

FIG. 5A illustrates wrapping a conduit tray, using layers of JFEM wherein longitudinally the butt seam BS between the outer layers is covered with collar C held in place with steel bands SB. FIGS. 5B and 5C illustrate alternate views of the embodiment of FIG. 5A.

FIG. 6A illustrates how two successive 30-inch tall sections of jacketed fibrous endothermic matting can be used to form a vessel skirt for a LPG container or vessel. The two sections are wrapped around the exterior of the lower 60-inches of the vessel. FIG. 6B illustrates the wrapping of the vessel skirt from a top view showing the overlap provided by two layers of thickness. Stainless steel banding is applied to the top and the bottom circumferentially of each 30 inch tall section. A 2-inch longitudinal overlap is provided for the wrapped sections, the overlap between adjacent sections staggered. FIG. 6C illustrates a vessel skirt of a jacketed fibrous endothermic mat JFEM in order to cover the bolts of a vessel for fireproofing. The shape of the jacketed mat is cut and determined in accordance with the dimension of the vessel. Again, stainless steel banding is used circumferentially at the top and the bottom of the jacket. The lower portion of the vessel is also shown covered with a jacketed mat. A 2-inch overlap on all layers is practiced.

FIG. 6D illustrates the possibility of covering a 1-inch conduit of pipe with a jacketed fibrous endothermic mat. The mat is sufficiently flexible to wrap around and form a double layer around a 1-inch diameter conduit or pipe. A minimum of 2-inch overlap is advised and again stainless steel banding SSB is utilized.

FIG. 6E illustrates the addition of a fireproofing system for valve covers comprising jacketed fibrous endothermic mat formed with an addition of an inner layer of stainless steel mesh to hold the shape of a formed jacket. The stem of the valve is covered with a formed bonnet cover, formed in two sections. The valve itself is covered with a removeable top cover.

The twenty-eight FIGS. 7A-7BB illustrate a jacket design and technique for wrapping a complex structural steel joint. The structural steel joint is shown in FIG. 7A, having concrete and sand fire protection over portions of the two horizontal I-beams and one vertical I-beam, all feeding into the joint. Nine jacketed endothermic fibrous mats JFEM are shown used to form three layers of jacketing around the two horizontal and one vertical I-beam. The first layer comprises jacketed mats 1.1, 1.2 and 1.3. The second layer comprises jacketed mats 2.1, 2.2 and 2.3. The third and outside layer comprises jacketed mats 3.1, 3.2 and 3.3. FIGS. 7B and 7C show jacketed mats 1.1 and 1.2. FIGS. 7D and 7E shows jacketed mats 1.1 and 1.2 tied with steel tie wires around the two horizontal I-beams to form the first wrapped layer of the horizontal pieces. FIG. 7F illustrates the jacketed mat 1.3 for the vertical piece of the first layer in place. FIGS. 7G and 7H illustrate the joint covered now with the first layer including horizontal layers 1.1 and 1.2 and vertical layer 1.3. All layers are affixed with tie wires. It can be seen that in the first layer horizontal pieces include flaps to extend out into the web or onto the flange of the vertical I-beam. FIGS. 7I, 7J and 7K illustrate two horizontal and one vertical jacketed mat to make up the second or middle layer of the wrapped composite. FIG. 7L is a close up of the wire spacing binding mat 2.2 to the horizontal I-beam. FIGS. 7M, 7N and 7O illustrate the second layer of the jacketed mats wrapped upon the two horizontal and one vertical I-beam. FIGS. 7P-7X illustrate the third layer of jacketed mats with jacketed mat 3.1 of FIG. 7P covering 1 horizontal, as per FIG. 7Q, and jacketed mat 3.2 of FIG. 7R covering the other horizontal as per FIGS. 7S, 7T and 7U. FIGS. 7S 7T and 7U also illustrate the banding used on the outer layer of jacketed mats. FIG. 7V illustrates the jacketed mat 3.3 for the vertical I-beam with FIGS. 7W and 7X illustrating the vertical jacketed mat of the exterior level wrapped around and bound on the vertical I-beam with steel banding.

FIG. 7Y illustrates the completely jacketed product showing the exterior levels. FIGS. 7Z, 7AA and 7BB illustrate the three jacketed mats used to cover respectively the two horizontal I-beams and the vertical I-beam.

In testing, some of which is discussed more fully below, the instant jacketed mat JFEM has been proven to:
(1) provide up to about 4 hours of fire protection for structural steel in accordance with UL 1709 (Rapid Rise Fire Tests of Protection Materials for Structural Steel);
(2) provide up to 2 hours of fire protection for electrical circuits in accordance to ASTM E 1725 (Fire Tests of Fire-Resistive Barrier Systems for Electrical System Components) per the hydrocarbon pool fire temperature curve (ASTM E 1529);
(3) comply with NFPA 58 Appendix H: Procedures for Torch Fire and Hose Stream Testing of Thermal Insulating Systems for LP-Gas Containers.

Testing generally indicates that structural steel items sized at W 10×49 or above can be protected with one layer of the jacketed mat per each hour of fire protection required.

Longitudinal seams of minimum 2-inch overlap are preferably provided, as well as minimum 4-inch wide collars to cover circumferential butt seams. Such designs can provide up to about 4 hours of protection per UL 1709.

Testing also shows that circuit protection on 1 inch and above diameter conduit can be provided by two layers to maintain 30 minutes, three layers to maintain 1 hour, and four layers to maintain 2 hours of protection, per ASTM E 1725.

Testing also shows that compliance to NFPA 58 Appendix H, above, can be achieved by 2 layers of the jacketed mat continuously wrapped with butt seams staggered by a minimum of 2 inches.

All applications preferably include 0.5 inch wide by 0.020 inch thick stainless steel banding installed at 1 inch from each seam and at 12 inches on center for biding the outer layer of the wrap. Stainless steel tie wire, 16 gauge, 2 to 4 inch center, can be used to bind inner layers.

The jacketed mat or composite is designed to endure typical industrial lifecycle exposures with an expected durability of 30+ years.

### Preferred Fibrous Endothermic Mat

The preferred fibrous endothermic mat is the Interam product produced by 3M. It is believed that the Endoflex mat produced by ETS Schaeffer, a fibrous endothermic mat, will also perform well.

Preferred Fiberglass Fabric Impregnated with Chemical, Water and Oil Resistant Compound

The jacketing material preferably includes fiberglass fabric impregnated with a chemical, water and oil resistant compound, preferably comprising a silicon rubber or Teflon resin impregnated material.

### Preferred Blanketing Techniques

Preferred blanketing techniques involve determining the number of layers of jacketed mat suitable to meet the requisite fire protection minimum time in given temperature circumstances. Mat sections are preferably wrapped with a minimum of 2-inch overlaps. The wrap of inner layers can be held in place by stainless steel wire, 16 ga. Sections can also employ butt seams, preferably wherein an at least 4 inch collar is centered over an outer butt seam and bound with steel banding. Preferably the steel bands are about a half inch wide. Recommended spacing for stainless steel tie wire of inner layers is every four to six inches. Any gaps between a quarter inch and two inches between sections possibly can be filled with a sealant meeting requisite fire protection standards. Circumferential butt seams are preferably offset at least two inches from each other on adjacent layers. A 4-inch wide circumferential collar is preferably centered over exterior butt seams. Steel banding, preferably stainless steel, is preferably spaced at a maximum of 12 inches apart and at 1 inch from the edge of each collar or interface termination.

### Preferred Embodiments

A jacketed fibrous endothermic mat is a flexible component designed to protect critical items that can be subjected to fire exposure. During a fire the core material releases chemically bound water in an endothermic reaction to the heat created by the fire, creating a cooling effect to the item protected. Flexible mat systems are ideal for industrial fire proofing due to their ability to conform to complex configurations and on various different substrates. A jacketed fibrous endothermic mat is removable to allow inspection or maintenance on the protected items. Table 1, below, indicates preferred jacketed fibrous endothermic mat compositions.

TABLE 1

| | |
|---|---|
| Blanket #1 | 3 layers of 17.5″ × 52″ E-Mat* inside one PTFE Coated |
| | fiberglass envelope |
| Blanket #2 | 3 layers of 17.5″ × 52″ E-Mat with 2″ of I-10** mat |
| | on top and bottom of each layer of E-Mat inside one PTFE |
| | Coated fiberglass envelope |
| Blanket #3 | Inner layer E-Mat, 2 layers of I-10 Mat in the middle, and |
| | another layer of E-Mat as the outer most layer. All 17.5″ × |
| | 52″ inside one PTFE Coated fiberglass envelope. |
| Blanket #4 | 147″ × 17.5″ of continuous E-Mat all inside one envelope. |
| Blanket #5 | 3 individually wrapped 17.5″ × 52″ E-Mat with 3″ of I-10 |
| | mat on top and bottom. |
| Blanket #6 | 3 individually wrapped 17.5″ × 52″ E-Mat. |

*Emat is a condensed name for Endothermic Mat from 3M, specifically Interam E 5A-4.
**I-10 mat is an intumescent mat material from 3M made from vermiculite and is used to seal gaps in refractory applications.

* Emat is a condensed name for Endothermic Mat from 3M, specifically Interam E 5A-4.** I-10 mat is an intumescent mat material from 3M made from vermiculite and is used to seal gaps in refractory applications.

### Performance of Preferred Embodiments

1. Can provide up to 4 hour fire protection on structural steel in accordance with UL 1709 (Rapid Rise Fire Tests of Protection Materials for Structural Steel).

2. Can provide up to 2 hour fire protection on electrical circuit protection in accordance with ASTM E 1725 (Fire Tests of Fire-Resistive Barrier Systems for Electrical System Components) per the hydrocarbon pool fire temperature curve (ASTM E 1529).

3. Can comply with NFPA 58 Appendix H: Procedures for Torch Fire and Hose Stream Testing of Thermal Insulating Systems for LP-Gas Containers.

### Features of Preferred Embodiments

Structural steel items sized at W 10×49 or above can be protected with one or more layers of jacketed fibrous endothermic mats, such as one layer per each hour of fire protection required. Longitudinal seams of minimum 2-inch overlap are preferred and a minimum 4-inch wide collar for circumferential seams are preferred to provide up to 4 hour protection per UL 1709. Circuit protection can be provided for 1-inch diameter conduit and above, preferably with two layers to maintain 30 minutes, three layers to maintain 1 hour and four layers for 2 hour protection per ASTM E 1725. For compliance with NFPA 58 Appendix H, 2 layers continuous with all butt seams staggered by a minimum of 2 inches are recommended. All applications preferably include 0.5 inch wide by 0.020 inch thick stainless steel banding installed at 1 inch from each seam and at 12 inches on center for outside layers.

### Physical Properties of Preferred Embodiments

### Exterior Color/Material: Dark Gray/PTFE Impregnated Fabric

### Maximum Continuous Temperature: 550° F. (288° C.)

Overall thickness: 0.432 inch (1.1 cm)
Density/Weight: 50 PCF/1.80 psf (800 kg/m²/8.9 kg/m²)
Impact Strength: 150 psi (1033 kPa)

### Thermal Conductivity: 0.087 BTU/ft-hr—° F. @ 200° F. (0.151 W/m—° C. @ 93 C)

0.101 BTU/ft-hr—° F. @ 350° F. (0.175 W/m—° C. @ 177 C)
0.058 BTU/ft-hr—° F. @ 600° F. (0.100 W/m—° C. @ 316 C)
0.068 BTU/ft-hr—° F. @ 750° F. (0.118 W/m—° C. @ 399 C)
0.081 BTU/ft-hr—° F. @ 900° F. (0.140 W/m—° C. @ 482 C)

### Testing

### 3M

An independent distributor of 3M brought a 3M product, Interam, a fibrous endothermic mat, to the attention of the inventors. The inventors were told that the Interam product was about 20 to 30 years old and that when Interam first came out the sales were good but in the last 10 to 20 years, sales had tapered off significantly. The inventors speculated that Interam's sales had tapered off for at least two reasons, especially in the structural steel market. First, while wrapping structural steel with an endothermic mat was easier, cheaper and less labor intensive than covering the structure with pyrocrete or concrete and sand (the current alternative,) Interam was only a partial solution. There did not appear to be a method disclosed for covering the structural “blockouts” or complex structural joints with the fibrous endothermic mat. Secondarily, users likely had concerns about whether the mat would weather satisfactorily in the industrial environment over twenty years or more, even with stainless steel sleeves.

The inventors envisioned that if they jacketed the fibrous endothermic mat with an appropriate jacketing material, as the inventors had experience with in regard to insulation materials they sold for “heat conservation” purposes, both problems might be solved. A properly jacketed fibrous endothermic mat might be able to be successfully wrapped around complex joints so as to pass the relevant ASTM and UL heat tests, notwithstanding the melting of the jackets, and would otherwise survive many years of exposure to the weather and workforce wear and tear.

The inventors produced prototype jacketed fibrous endothermic mats for testing against the high ASTM standard test for structural steel to determine the effect of jacketing on the mats, jacketing with a material that would acknowledgeably dissolve or dissipate or melt early on in the tests, as discussed above. At the invitation of 3M, the inventors first tested the prototypes at 3M test facilities. (The inventors were politely led to understand that 3M was prepared to assist in the “redesigns” of the product, 3M anticipating that the inventors' newly designed prototypes would fail the tests.) Surprisingly, the prototypes not only passed all of the tests but exceeded expectations. The initial testing, conducted at 3M, proved, surprisingly, that the jacketing did not inhibit the fire protective features of the fibrous endothermic mats. In fact, again surprisingly, the jacketed material outperformed 3M's fibrous endothermic mat alone, even though at approximately 1000° F. the jacketing material had indeed dissolved.

As for enduring 10 to 20 years of weather and workforce wear and tear, the inventors rely upon their independent experience and testing using analogous jacketing materials with other insulation materials in the industrial environment, to substantiate expected success.

### Testing

### SWRI

### Structural Steel

### Objective

The objective of this testing was to evaluate the fire resistance performance of jacketed fibrous endothermic mats when applied to a structural steel W10×49 column tested in accordance with UL 1709, Standard for Rapid Rise Fire Tests of Protection Materials for Structural Steel, full-scale test exposure.

### Test Method

The UL 1709 fire test method for the protection of structural steel columns is intended to evaluate the duration for which material can thermally protect structural steel columns during a predetermined fire exposure time. This test measures the response of the assembly to exposure in terms of the transmission of heat into the assembly.

### Sample Description and Construction

The tested assemblies were three W10×49 columns, which were each 9 ft in height. The assemblies were all protected with jacketed fibrous endothermic mats insulation comprising an endothermic mat insulation enclosed with a PTFE impregnated cloth.

The jacketed fibrous endothermic mats were installed on the columns first with 16-ga stainless steel tie-wire to hold the blankets in place prior to the stainless steel banding. Stainless steel bands were then installed at 1 inch from all circumferential overlap seams and at every 12 inches on center. Each layer of jacketed fibrous endothermic mats was installed by tightly wrapping it around the column so that a minimum 2-inch overlap was present along the longitudinal seam (the actual installation for the columns had a 4-inch overlap). The seams were located on the column flanges. Adjacent sections of material on the same layer abutted one another forming a circumferential butt seam. Successive layers of mat were installed in same manner with butted end seams offset a minimum of 2 inches from butted end seams of preceding layer. A 4-inch wide mat collar was wrapped around each outer layer circumferential butt joint with a 2-inch overlap on itself. Stainless steel bands were applied at 1 inch from collar edges and at maximum 2 inches on center.

Column 1 was protected by a single layer of mats, which measured nominally 48×48×0.5 inches (L×W×T). The mats were installed in the manner described above. These single sheets had a measured thickness of 0.85 inches and consisted of two layers of endothermic mat material contained in a single PTFE impregnated cloth.

Column 2 was protected by two separate layers of mats, each of which measured nominally 48×48×0.40 inches (L×W×T). The mats were installed in the manner described above. The mats on this column consisted of one layer of endothermic mat material contained in a PTFE impregnated cloth. The first layer of this protection system was installed only using stainless steel tie-wires and the second layer of the system was installed with tie-wires first, and then was permanently banded.

Column 3 was protected by three separate layers of mats, which measured nominally 48×48×0.40 inches (L×W×T). The mats were installed in the manner described above. The mats on this column consisted of one layer of endothermic mat material contained in a PTFE impregnated cloth. The first and second layer of this protection system were installed only using stainless steel tie-wires and the third (outer most) layer of the system was installed with tie-wires first, and then was permanently banded.

MIL-STD-3020 references the UL 1709 furnace conditions. (Note: the radiometer locations for the instant testing were somewhat different than as specified in UL 1709.) Per the MIL-STD-3020 calibration procedure, SwRI's vertical-furnace produced a target total heat flux level of 204 kW/m² at an average furnace temperature of 2006° F. The maximum allowable heat flux level of 220 kW/m² was achieved at an average furnace temperature of 2056° F., and the minimum allowable heat flux level of 188 kW/m² corresponded to an average temperature of 1957° F.

### Results

Test Date: Feb. 28, 2013
Test Witnesses: Mr. Barry B adders, representing SwRI
   Mr. Wane “Doug” Whitaker, representing SwRI
   Mr. Jed Moore, representing Specialty Insulation Solutions
   Mr. Darrell Kunk, representing Specialty Insulation Solutions
   Mr. Brandon Kunk, representing Specialty Insulation Solutions
   Mr. Joshua Vestal, representing Intertek (certification agency)
Ambient Temperature: 61.8° F.
Relative Humidity: 26%
Instrumentation: A total of 12 thermocouples (TCs) were applied to each of the columns at four different elevations for a total of three TCs per elevation. A drawing of the TC locations can be found in Appendix A.
   Nine additional bare wire TCs were included within the furnace to monitor and control the furnace atmosphere during testing. One differential pressure probe was included within the furnace to measure the internal furnace pressure.
Load: Not required.
Observations: No observations were made during the test since the columns were mounted on a steel wall that sealed the vertical furnace.
Hose Stream Test: Not required.
Results: The protected structural steel column assembly was mounted on a steel wall and immersed in SwRI's large-vertical furnace for testing. Instrumentation connections were verified, and the UL 1709 exposure was initiated. The columns were exposed to the UL 1709 exposure conditions for three hrs.
   The performance criteria for full length steel columns, according to UL 1709, is worded such that the transmission of heat through the protection material during the period of fire exposure for which classification is desired shall not raise the average temperature at any of the four levels of the steel column above 1000° F. and no TC shall indicated a temperature greater than 1200° F.
   At 1 hr 36 minutes 42 seconds into the test, the average temperature of TCs 1-3 on Column 1, which were the top elevation level of this column, registered a temperature of 1001° F.
   At 1 hr 39 minutes 21 seconds into the test, the average temperature of TCs 13-15 on Column 2, which were the top elevation level of this column, registered a temperature of 1001° F.
   At 2 hr 55 minutes into the test, the average temperature of TCs 25-27 on Column 3, which were the top elevation level of this column, registered a temperature of 1001° F.

### Conclusion

Based on the test results, the structural steel columns with jacketed fibrous endothermic mats installed as described achieved fire resistance ratings as follows. Column 1 achieved a fire resistance rating of 1 hr 36 min; column 2 achieved a fire resistance rating of 1 hr 39 min; and column 3 achieved a fire resistance rating of 2 hr 55 min.

Intertek certified the product as a result of the above testing.

### Testing

### SWRI

### Components of Electrical System

The ASTM E 1725 fire test method evaluates the duration for which material can thermally protect components of an electrical system during a predetermined fire exposure time. Test specimens vary in construction (i.e. electrical conduit or cable trays) and orientations. The test measures the response of the assembly to exposure in terms of the transmission of heat into the assembly.

The tested assemblies were two aluminum conduits of different outer diameters and layers of insulation. One conduit was 1-inch O.D. and the other conduit was 4-inch O.D. The conduits were U shaped with nominal 60 inch width in between the two legs of the U, and the legs of the U were nominal 72 inch long. The conduits were installed such that 36 inch of the legs, along with the horizontal stretch of the conduit, were immersed within the furnace. The remaining 36 inch of each leg of the conduit extended through the test wall to the exterior area of the furnace.

The exposed surface area of the conduits was protected with Interam fibrous endothermic mat insulation enclosed with a PTFE impregnated cloth.

The jacketed mats were installed on the conduits first with 16-ga stainless steel tie-wire to hold the blankets in place prior to the stainless steel banding. The stainless steel bands were then installed at 1 inch from all circumferential overlap seams and at every 12 inch on center. Each layer of the jacketed mats was installed by tightly wrapping it around the conduit so that a minimum 2-inch overlap was present along the longitudinal seam. Adjacent sections of material on the same layer abutted one another forming a circumferential butt seam. Successive layers of mat were installed in same manner with butted end seams offset a min 2 inch from butted end seams of preceding layer. A 4-inch wide mat collar was wrapped around each outer layer circumferential butt joint with a 2-inch overlap on itself. Stainless steel bands were applied at 1 inch from collar edges and at maximum 12 inch on center.

The 4-inch O.D. aluminum conduit was protected by two layers of jacketed mats, which measured nominally 48×48×0.40 inch (L×W×T). These mats had a nominal thickness of 0.40 inch and consisted of two separate layers of fibrous endothermic mat material, each contained in their own PTFE impregnated cloth cover. The first layer of this protection system was installed only using stainless steel tie-wires and the second layer of the system was installed with tie-wires first, and then was permanently banded with stainless steel banding.

The 1-inch O.D. aluminum conduit was protected by three separate layers of jacketed mats, which measured nominally 48×48×0.40 inch (L×W×T). The jacketed mats on this conduit consisted of three separate layers of fibrous endothermic mat material, each contained in their own PTFE impregnated cloth clover. The first and second layer of this protection system were installed only using stainless steel tie-wires and the third (outer most) layer of the system was installed with tie-wires first, and then was permanently banded with stainless steel banding.

Based on the test results, the aluminum conduits with the jacketed mats installed as described in this report, achieved a fire resistance ratings as follows. The 4-inch aluminum conduit with two layers of jacketed matting achieved a fire resistance rating of 45 min. The 1-inch aluminum conduit with three layers of jacketed matting achieved a fire resistance rating of 1 hr 8 min.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. A jacketed mat for fire protection of structural elements such as steel I-beams and joints, electrical conduit and cable trays, LP-gas containers and vessel skirts and valves, comprising:
a flexible jacket including a fiberglass material impregnated with a chemical, water and oil resistant compound, the jacket enclosing one or more fibrous endothermic mats, the jacket having a melting temperature of approximately 500° F.+/−100° F.

2. The jacketed mat of claim 1 wherein the fibrous endothermic mat includes at least one of Interam and Endoflex.

3. The jacketed mat of claim 1 wherein the impregnating compound includes a silicon rubber or Teflon resin.

4. The jacketed mat of claim 1 that includes a jacket segmented into portions.

5. A method of providing fire protection from fire for structural elements such as steel I-beams and joints, electrical conduits and cable trays, LP-gas containers and vessel skirts and valves, comprising:
wrapping and binding two or more jacketed mats of claim 1 around one or more structural elements with an overlap of between 2 inches and 8 inches and a thickness of between 1 inch and 4 inches, such that the wrapped structural element passes the relevant UL/ASTM/NFPA fire protection test for certifying the jacketed mats.

6. A composite for the protection of industrial structural elements such as steel I-beams and structural joints, electrical conduits and cable trays, LP-gas containers and vessel skirts and valves, from sustained fire, comprising:
a flexible jacket including material impervious to weather and industrial workplace wear and tear, the jacket structured and composed to maintain integrity under workplace abrasive contact and exposure to oil and water;
the jacket enclosing an approximately ¼ inch to 5 inch thickness of one or more fibrous endothermic mats to form a composite;
the composite composed and structured for binding around a portion of an industrial structural element;
the one or more fibrous endothermic mats capable of at least meeting the standards of at least one of the ASTM E 119 test and UL 1709 test for structural steel.

7. The composite of claim 6 wherein the jacket material includes a fiberglass fabric material impregnated with a water, oil and chemical resistant compound.

8. The composite of claim 6 wherein the jacket material includes a fabric material coated and/or impregnated and/or laminated with a water, oil and chemical resistant compound.

9. The composite of claim 6 wherein the jacket material has a melting, dissolving, decomposing temperature of greater than or equal to 400° F.

10. The composite of claim 6 wherein the jacket material has a melting, dissolving, decomposing temperature of approximately 500° F.±100° F.

11. The composite of claim 6 including the composite formed into an approximately rectangular blanket of between one square foot and ten square feet in extent.

12. A method for protecting industrial structural elements such as steel I-beams and structural joints, electrical conduits and cable trays, LP-gas containers and vessel skirts and valves, from sustained fire, comprising:
enclosing a portion of the structural element with at least one fire protective composite of claim 6.

13. The method of claim 12 including layering a plurality of fire protective composites of claim 6 around the structural element portion.

14. The method of claim 12 including overlapping a plurality of fire protective composites of claim 6 around the portion of the structural element.

15. The method of claim 12 including binding the composite or composites around the structural element.

16. The method of claim 12 including the composite of claim 6 demonstrating superior performance, under at least one of the ASTM E 119 test and the UL 1709 test, to the fibrous endothermic mat material alone.

17. The method of claim 14 including binding at least twice a collar unit formed of the fire protective composite of claim 6 to overlap a seam between either a plurality of fire protective composites of claim 6 or a fire protective composite of claim 6 and a concrete structural element.

18. The method of claim 13 including binding the composite or composites around the structural element.

19. The method of claim 14 including binding the composite or composites around the structural element.
